(19) United States
(12) Patent Application Publication
(10) Pub. No.: US 2025/0079672 A1
(43) Pub. Date: Mar. 6, 2025

(54) TEMPORARY SEALING PLUG, POWER STORAGE CELL, AND METHOD OF MANUFACTURING POWER STORAGE CELL

(71) Applicant: TOYOTA JIDOSHA KABUSHIKI KAISHA, Toyota-shi Aichi-ken (JP)

(72) Inventors: Takeru HARA, Toyota-shi Aichi-ken (JP); Masato ONO, Nagoya-shi Aichi-ken (JP); Satoshi MORIYAMA, Nagoya-shi Aichi-ken (JP); Hiroki AWANO, Susono-shi Shizuoka-ken (JP); Kazuya KUMAZAWA, Nagoya-shi Aichi-ken (JP); Seigo FUJISHIMA, Miyoshi-shi Aichi-ken (JP); Tomohiro INAGAKI, Okazaki-shi Aichi-ken (JP)

(73) Assignee: TOYOTA JIDOSHA KABUSHIKI KAISHA, Toyota-shi Aichi-ken (JP)

(21) Appl. No.: 18/812,397

(22) Filed: Aug. 22, 2024

(30) Foreign Application Priority Data
Aug. 29, 2023 (JP) 2023-138996

(51) Int. Cl. H01M 50/664

(52) U.S. Cl. CPC H01M 50/664

(57) ABSTRACT

A temporary sealing plug is used to temporarily close an injection port of a power storage cell after injection. The temporary sealing plug includes a central portion and a peripheral edge portion. When viewed in a plan view, the peripheral edge portion surrounds the central portion. A cut extending radially from the central portion toward the peripheral edge portion is formed.

### CROSS REFERENCE TO RELATED APPLICATIONS

This nonprovisional application is based on Japanese Patent Application No. 2023-138996 filed on Aug. 29, 2023 with the Japan Patent Office, the entire contents of which are hereby incorporated by reference.

### BACKGROUND

### Field

The present disclosure relates to a temporary sealing plug, a power storage cell, and a method of manufacturing a power storage cell.

### Description of the Background Art

Japanese Patent Laying-Open No. 2019-145294 discloses an injection port.

### SUMMARY

A process of manufacturing a power storage cell includes “injection” and “sealing”. That is, an electrolyte solution is injected into a case from an injection port. After the electrolyte solution is injected, the injection port is closed by a sealing plug. There is a possibility that the electrolyte solution may be volatilized from the injection port during a period of time from the injection to the sealing. For example, it is considered to temporarily close the injection port by a temporary sealing plug.

Initial charging may be performed during the period of time from the injection to the sealing. At the time of initial charging, gas is generated by decomposition of the electrolyte solution. In order to maintain internal pressure of the case within a predetermined range, it is desirable to discharge the gas from the injection port. Therefore, it is required to remove the temporary sealing plug at the time of initial charging. When the waiting time until the sealing after the initial charging is long, it is required to close the injection port again by the temporary sealing plug. The operation of attaching and detaching the temporary sealing plug may lead to decreased manufacturing efficiency.

There is provided a temporary sealing plug that does not need to be attached and detached.

1. In one aspect of the present disclosure, a temporary sealing plug is provided. The temporary sealing plug is used to temporarily close an injection port of a power storage cell after injection. The temporary sealing plug includes: a central portion; and a peripheral edge portion. When viewed in a plan view, the peripheral edge portion surrounds the central portion. A cut extending radially from the central portion toward the peripheral edge portion is formed.

The temporary sealing plug is attached to the injection port of the case. A nozzle is inserted into the cut of the temporary sealing plug. The electrolyte solution is injected into the case from the nozzle. The nozzle is pulled out from the temporary sealing plug. The cut can be naturally closed due to restoring force of the material. By attaching the sealing plug so as to cover the temporary sealing plug, the case can be sealed. That is, the injection and the sealing can be performed without attaching and detaching the temporary sealing plug.

2. The temporary sealing plug according to “1” may include, for example, the following configuration. The temporary sealing plug includes at least one selected from a group consisting of ethylene-propylene-diene rubber (EPDM), perfluoroalkoxy fluororesin (PFA), and polytetrafluoroethylene (PTFE).

Each of rubber materials and resin materials is expected to exhibit a suitable restoring force. Each of the EPDM, the PFA, and the PTFE is expected to exhibit resistance to the electrolyte solution.

3. The temporary sealing plug according to “1” or “2” may include, for example, the following configuration. The central portion is raised.

When the raised central portion is sandwiched by, for example, a clamp or the like, volatilization of the electrolyte solution can be reduced.

4. In one aspect of the present disclosure, a power storage cell is provided. The power storage cell includes: the temporary sealing plug according to any one of “1” to “3”; a sealing plug; a case; an electrode assembly; and an electrolyte solution. The case accommodates the electrode assembly and the electrolyte solution. The case is provided with an injection port. The sealing plug closes the injection port. The temporary sealing plug is disposed between the injection port and the sealing plug.

The sealing can be performed with the temporary sealing plug remaining therebetween.

5. In one aspect of the present disclosure, a method of manufacturing a power storage cell is provided. The method of manufacturing the power storage cell includes the following (a) to (c):
(a) preparing a case provided with an injection port;
(b) accommodating the electrode assembly in the case; and
(c) injecting an electrolyte solution into the case.

Further, the (c) includes the following (c1) to (c4) in this order:
(c1) attaching the temporary sealing plug according to any one of “1” to “3” to the injection port;
(c2) inserting a nozzle into the cut of the temporary sealing plug;
(c3) injecting the electrolyte solution from the nozzle; and
(c4) pulling out the nozzle from the temporary sealing plug.

Hereinafter, an embodiment (hereinafter, simply referred to as “the present embodiment”) of the present disclosure will be described. It should be noted that the present embodiment does not limit the technical scope of the present disclosure. The present embodiment is illustrative in any respects. The present embodiment is non-restrictive. The technical scope of the present disclosure includes any modifications within the scope and meaning equivalent to the terms of the claims. For example, it is initially expected to extract freely configurations from the present embodiment and combine them freely.

Geometric terms should not be interpreted in a strict sense. Examples of the geometric terms include “parallel”, “perpendicular”, “orthogonal”, and the like. For example, the term “parallel” may be deviated to some extent from the strict definition of the term “parallel”. The geometric terms can include, for example, a tolerance, an error, and the like in terms of design, operation, manufacturing, and the like. A dimensional relation in each of the figures may not coincide with an actual dimensional relation. In order to facilitate understanding of the reader, the dimensional relation in each figure may be changed. For example, length, width, thickness, or the like may be changed. Further, part of configurations may be omitted.

The expression “when viewed in a plan view” indicates to view an object along a line of sight parallel to the thickness direction of the object. The expression “when viewed in a plan view” is indicated in a plan view.

An order of execution of a plurality of steps, operations, actions or the like included in each of various methods is not limited to the described order unless otherwise stated particularly. For example, a plurality of steps may be performed simultaneously. For example, a plurality of steps may be performed earlier or later.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic plan view showing an example of a temporary sealing plug according to the present embodiment.

FIG. 2 is a first schematic cross-sectional view showing an example of a temporary sealing plug according to the present embodiment.

FIG. 3 is a second schematic cross-sectional view showing an example of the temporary sealing plug according to the present embodiment.

FIG. 4 is a schematic flowchart of a method of manufacturing a power storage cell according to the present embodiment.

FIG. 5 is a first schematic view showing the method of manufacturing the power storage cell according to the present embodiment.

FIG. 6 is a second schematic view showing the method of manufacturing the power storage cell according to the present embodiment.

FIG. 7 is a third schematic view showing the method of manufacturing the power storage cell according to the present embodiment.

FIG. 8 is a fourth schematic view showing the method of manufacturing the power storage cell according to the present embodiment.

FIG. 9 is a schematic cross-sectional view showing an example of a power storage cell according to the present embodiment.

FIG. 10 is a schematic cross-sectional view illustrating an example of an electrode assembly according to the present embodiment.

### DESCRIPTION OF THE EMBODIMENTS

### 1. Temporary Sealing Plug

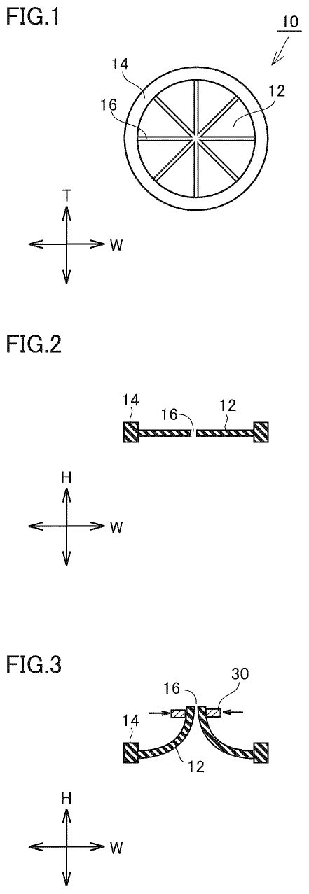

FIG. 1 is a schematic plan view showing an example of a temporary sealing plug according to the present embodiment. FIG. 2 is a first schematic cross-sectional view showing an example of a temporary sealing plug according to the present embodiment. The temporary sealing plug 10 may have any external shape. The temporary sealing plug 10 may be, for example, a circular plate, an elliptical plate, or a rectangular plate. The temporary sealing plug 10 may have a structure similar to a chrysanthemum-cracked lid, for example. The temporary sealing plug 10 includes a central portion 12 and a peripheral edge portion 14. The central portion 12 includes a geometric center of the temporary sealing plug 10. The geometric center of the temporary sealing plug 10 may coincide with the geometric center of the central portion 12. The contour line of the central portion 12 may be circular. The ratio of the maximum diameter of the central portion 12 to the maximum diameter of the temporary sealing plug 10 may be, for example, 0.9 or less, 0.8 or less, 0.7 or less, 0.6 or less, 0.5 or less, 0.4 or less, 0.3 or less, 0.2 or less, or 0.1 or less. The same ratio may be, for example, 0.1 or more, 0.2 or more, 0.3 or more, 0.4 or more, 0.5 or more, 0.6 or more, 0.7 or more, 0.8 or more, or 0.9 or more.

The peripheral edge portion 14 surrounds the central portion 12. The peripheral edge portion 14 may have, for example, a flange shape. A cut 16 is formed in the temporary sealing plug 10. The cut 16 penetrates the temporary sealing plug 10 in the thickness direction. The cuts 16 extend radially from the central portion 12 toward the peripheral edge portion 14. The plurality of cuts 16 may pass through a geometric center. The plurality of cuts 16 may intersect at a geometric center.

FIG. 3 is a second schematic cross-sectional view showing an example of the temporary sealing plug according to the present embodiment. The central portion 12 may be raised in one direction. Since the central portion 12 is raised, for example, the clamp 30 or the like can sandwich the central portion 12. By sandwiching the central portion 12, volatilization of the electrolyte solution can be reduced.

The temporary sealing plug 10 is an elastic body. When deformation occurs in the temporary sealing plug 10, a restoring force may be generated. The temporary sealing plug 10 may have resistance to the electrolyte solution. The temporary sealing plug 10 may be made of rubber, resin, or the like, for example. The temporary sealing plug 10 may contain at least one selected from the group consisting of butyl rubber, styrene-propylene rubber, EPDM, styrene-butadiene rubber, nitrile rubber, fluoro-rubber, natural rubber, PFA, and PTFE.

### 2. Method of Manufacturing Power Storage Cell

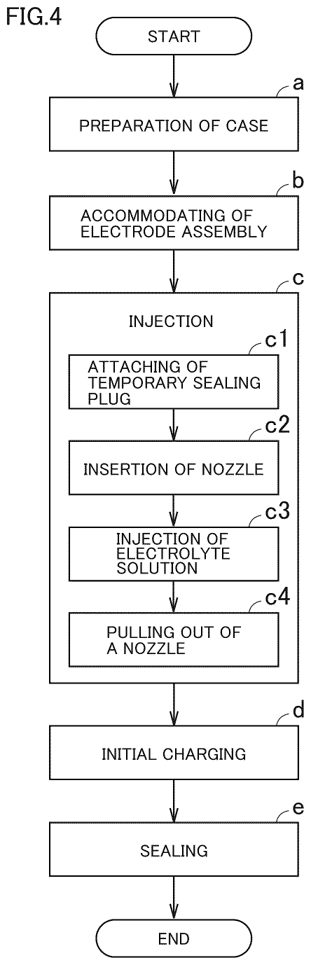

FIG. 4 is a schematic flowchart of a method of manufacturing a power storage cell according to the present embodiment. Hereinafter, the “method of manufacturing a power storage cell in the present embodiment” may be abbreviated as “the manufacturing method”. The manufacturing method includes “(a) preparation of case”, “(b) accommodating of electrode assembly”, and “(c) injection” in this order. The manufacturing method may further include “(d) initial charging”, “(e) sealing”, and the like.

### (a) Preparation of Case

FIG. 5 is a first schematic view showing the method of manufacturing the power storage cell according to the present embodiment. The manufacturing method includes providing the case 200. Case 200 may include a container 210 and a lid 220. The case 200 has an injection port 221. For example, the lid 220 may be provided with the injection port 221.

### (b) Accommodating of Electrode Assembly

The manufacturing method includes accommodating the electrode assembly 100 in the case 200. For example, the electrode assembly 100 is inserted into the container 210 from the opening of the container 210. After the insertion of the electrode assembly 100, the opening may be closed by the lid 220. For example, the lid 220 may be welded to the container 210 by laser machining.

### (c) Injection

The manufacturing method includes injecting an electrolyte solution into the case 200. Specific injection operations include “(c1) attaching of temporary sealing plug”, “(c2) insertion of nozzle”, “(c3) injection of electrolyte solution”, and “(c4) pulling out of nozzle” in this order.

### (c1) Attaching of Temporary Sealing Plug

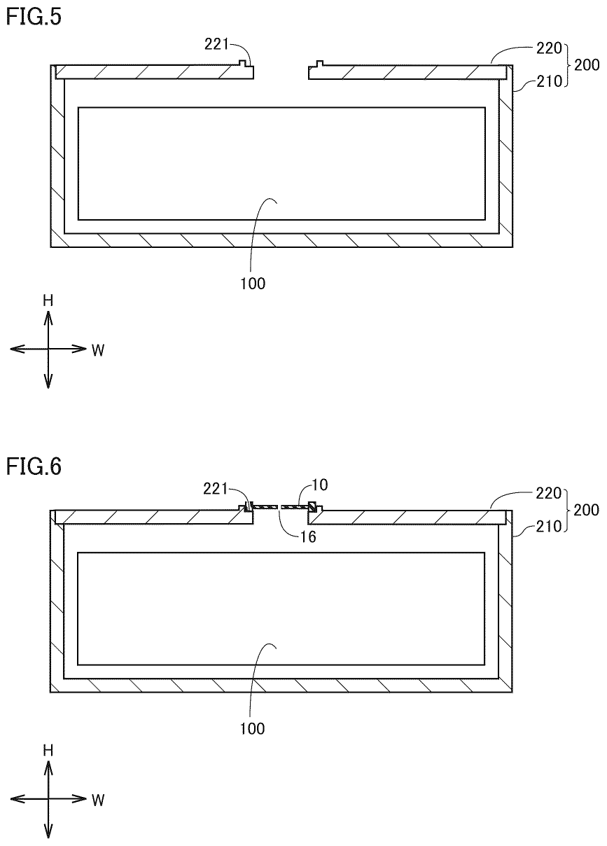

FIG. 6 is a second schematic view showing the method of manufacturing the power storage cell according to the present embodiment. The manufacturing method includes attaching the temporary sealing plug 10 to the injection port 221. For example, the temporary sealing plug 10 may be press-fitted into the injection port 221. The temporary sealing plug 10 may be attached at any timing. For example, the temporary sealing plug 10 may be attached in “(a) preparation of case” or “(b) accommodating of electrode assembly”.

### (c2) Insertion of Nozzle

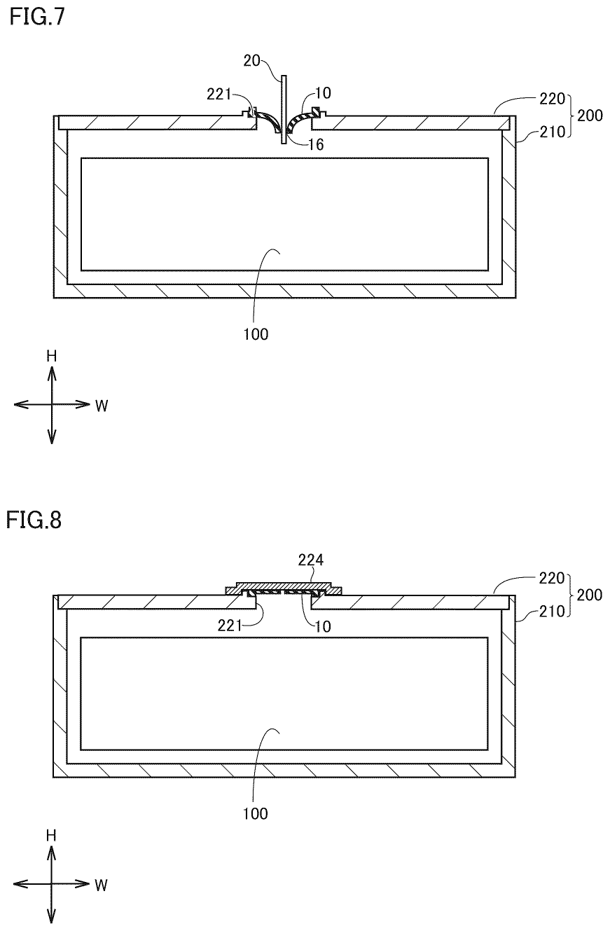

FIG. 7 is a third schematic view showing the method of manufacturing the power storage cell according to the present embodiment. The manufacturing method includes inserting the nozzle 20 into the cut 16 of the temporary sealing plug 10. The nozzle 20 may be inserted near the geometric center of the temporary sealing plug 10, for example.

### (c3) Injection of Electrolyte Solution

The manufacturing method includes injecting an electrolyte solution from the nozzle 20. The temporary sealing plug 10 can shield the bounce of the electrolyte solution.

### (c4) Pulling Out of Nozzle

The manufacturing method includes pulling out the nozzle 20 from the temporary sealing plug 10. After a predetermined amount of electrolyte solution is injected, the nozzle 20 is pulled out. The cut 16 may be blocked by the restoring force of the temporary sealing plug 10. That is, the temporary sealing plug 10 returns to the state shown in FIG. 6. When the central portion 12 of the temporary sealing plug 10 is raised, the central portion 12 may be clamped by the clamp 30 (see FIG. 3).

### (d) Initial Charging

The manufacturing method may include performing initial charging. At the time of initial charging, gas is generated by decomposition of the electrolyte solution. Due to the increase in the internal pressure, the cut 16 of the temporary sealing plug 10 can be slightly opened. Gas may be released from cut 16. During the initial charge, the temporary sealing plug 10 may reduce volatilization of the electrolyte solution.

### (e) Sealing

FIG. 8 is a fourth schematic view showing the method of manufacturing the power storage cell according to the present embodiment. The manufacturing method may further include closing the injection port 221 with a sealing plug 224. The sealing plug 224 may be attached in a state in which the temporary sealing plug 10 remains. That is, the temporary sealing plug 10 is disposed between the injection port 221 and the sealing plug 224. For example, the sealing plug 224 may be welded to the case 200 by laser processing.

### 3. Power Storage Cell

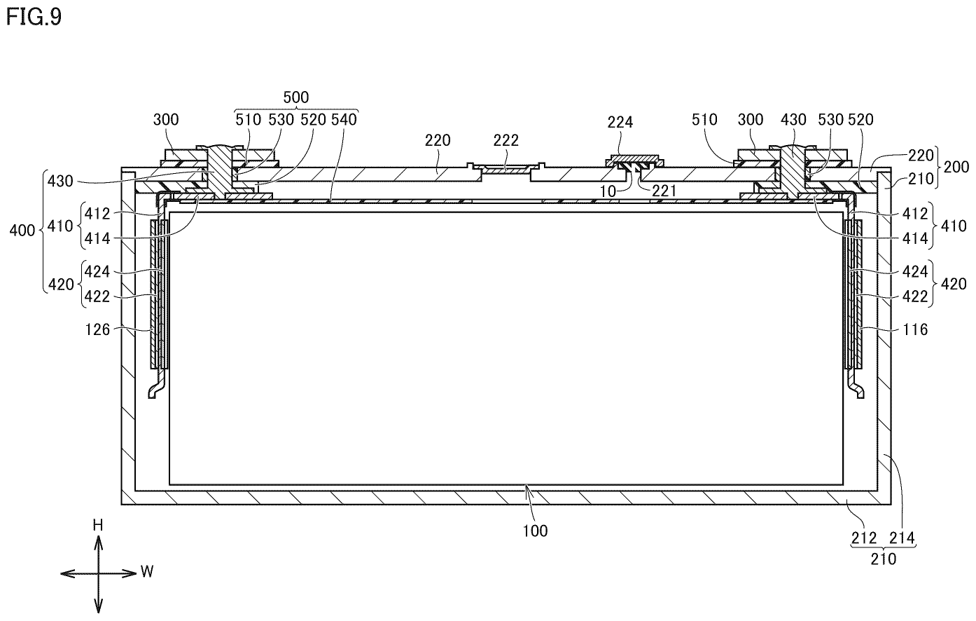

Hereinafter, a power storage cell suitable for the manufacturing method will be described. FIG. 9 is a schematic cross-sectional view showing an example of a power storage cell according to the present embodiment. The power storage cell 1 includes a temporary sealing plug 10, a sealing plug 224, a case 200, an electrode assembly 100, and an electrolyte solution (not shown). The electrolyte solution is a liquid electrolyte. The electrolyte solution may contain, for example, an organic solvent and a lithium salt.

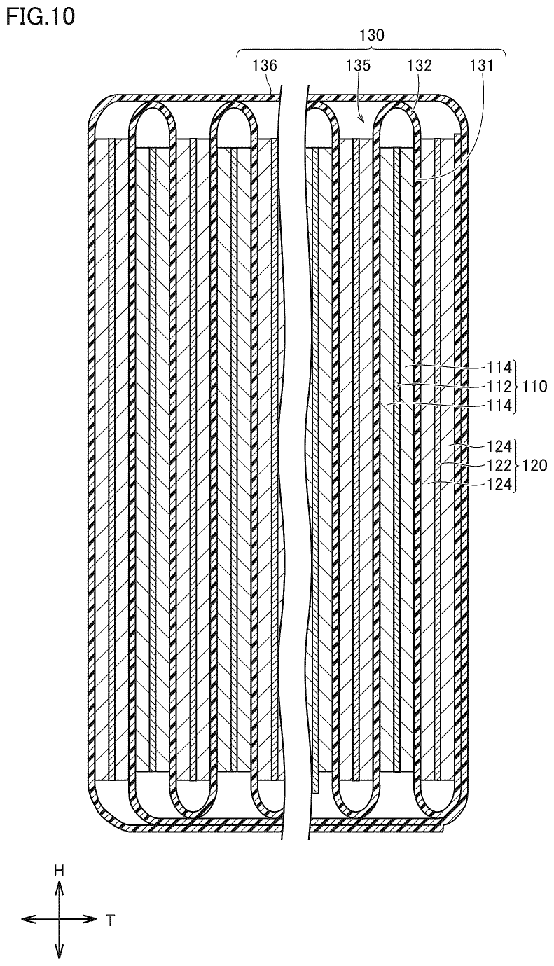

The power storage cell 1 may have, for example, a height direction, a width direction, and a thickness direction. The height direction, the width direction, and the thickness direction are orthogonal to each other. The “height direction” is the H direction in FIG. 9 and the like. The “width direction” is the W direction in FIG. 9 and the like. The “thickness direction” is the T direction in FIG. 10 and the like. The height direction may be parallel to the vertical direction, for example. The width direction and the thickness direction may be parallel to the horizontal direction, for example. The “height” indicates the dimension in the height direction. The “width” indicates a dimension in the width direction. The term “thickness” refers to the dimension in the thickness direction or the thickness of an object.

The case 200 accommodates the electrolyte solution and the electrode assembly 100. The case 200 may be hermetically sealed. The case 200 may be sealed. The case 200 may include a plurality of members. The case 200 may have a rectangular parallelepiped outer shape. The case 200 may include, for example, a container 210 and a lid 220. The container 210 includes a bottom wall 212 and a peripheral wall 214. The width of the peripheral wall 214 may be greater than the thickness of the peripheral wall 214. The height of the peripheral wall 214 may be greater than the thickness of the peripheral wall 214. Here, the “thickness of the peripheral wall 214” indicates the outer dimension of the case 200 in the depth direction in FIG. 9.

The lid 220 closes the opening of the container 210. The lid 220 may have, for example, a flat plate shape. The lid 220 may include, for example, a pressure-release valve 222 or the like. The pressure-release valve 222 releases the internal pressure of the case 200. Once the internal pressure becomes equal to or more than the setting value, the pressure-release valve 222 may be opened. The sealing plug 224 seals the injection port 221. The temporary sealing plug 10 is disposed between the injection port 221 and the sealing plug 224.

The electrode assembly 100 may have, for example, a cubic outer shape. The electrode assembly 100 may have, for example, a rectangular parallelepiped outer shape. The electrode assembly 100 may have, for example, a flat rectangular parallelepiped shape. The electrode assembly 100 may be covered with, for example, an insulating film (not illustrated).

The “first aspect ratio” indicates the ratio of the width to the height in the electrode assembly 100. The first aspect ratio may be, for example, 1 or more, 1.5 or more, 2 or more, 2.5 or more, 3 or more, 5 or more, or 10 or more. The first aspect ratio may be, for example, 10 or less, 5 or less, 3 or less, 2.5 or less, 2 or less, or 1.5 or less. The “second aspect ratio” indicates the ratio of the thickness to the height in the electrode assembly 100. The second aspect ratio may be, for example, 0.1 or more, 0.2 or more, 0.3 or more, 0.5 or more, or 1 or more. The second aspect ratio may be, for example, 1 or less, 0.5 or less, 0.3 or less, or 0.2 or less.

The electrode assembly 100 may have any structure. The electrode assembly 100 may be, for example, a wound type. The electrode assembly 100 may be, for example, a stacked type.

FIG. 10 is a schematic cross-sectional view illustrating an example of an electrode assembly according to the present embodiment. The electrode assembly 100 in FIG. 10 is a stacked type. The electrode assembly 100 includes one or more first electrodes 110, one or more second electrodes 120, and one or more separators 130. In the T direction, the first electrodes 110 and the second electrodes 120 are alternately stacked. That is, the T direction of the power storage cell 1 is parallel to the stacking direction of the first electrode 110 and the second electrode 120. The number of the first electrode 110 and the second electrode 120 may be 2 or more, 5 or more, 10 or more, 50 or more, or 100 or more. The number of each of the first electrode 110 and the second electrode 120 may be 200 or less, 100 or less, 50 or less, 10 or less, or 5 or less.

The second electrode 120 has a polarity different from that of the first electrode 110. For example, the first electrode 110 may be a positive electrode, and the second electrode 120 may be a negative electrode. For example, the first electrode 110 may be a negative electrode, and the second electrode 120 may be a positive electrode.

The first electrode 110 may include, for example, a first current collector 112 and a first active material layer 114. The first current collector 112 may include, for example, a metal foil or the like. The metal foil may contain, for example, Al, Cu, Ni, Ti, Fe, or the like. The first active material layer 114 is disposed on the surface of the first current collector 112. The first active material layer 114 may be disposed on only one surface of the first current collector 112. The first active material layer 114 may be disposed on both surfaces of the first current collector 112. The first active material layer 114 includes a positive electrode active material or a negative electrode active material. The positive electrode active material may include, for example, a lithium-nickel composite oxide or the like. The negative electrode active material may contain, for example, graphite, SiO, Si, or the like.

The second electrode 120 may include, for example, a second current collector 122 and a second active material layer 124. The second current collector 122 may include, for example, a metal foil or the like. The second active material layer 124 is disposed on the surface of the second current collector 122. The second active material layer 124 may be disposed on only one surface of the second current collector 122. The second active material layer 124 may be disposed on both surfaces of the second current collector 122. The second active material layer 124 includes a positive electrode active material or a negative electrode active material. The area of the second active material layer 124 may be the same as or different from that of the first active material layer 114. For example, the area of the second active material layer 124 may be larger than the area of the first active material layer 114. The ratio of the area of the second active material layer 124 to the area of the first active material layer 114 may be, for example, 1.01 or more, 1.05 or more, or 1.1 or more. The ratio of the area of the second active material layer 124 to the area of the first active material layer 114 may be, for example, 1.1 or less, 1.05 or less, or 1.01 or less.

The separator 130 has electrical insulation properties. The separator 130 is porous. The separator 130 may include, for example, a microporous polyolefin film or the like. The thickness of the separator 130 may be, for example, 5 to 50 μm, 5 to 30 μm, or 5 to 15 μm. The separator 130 separates the first electrode 110 from the second electrode 120. For example, two or more separators 130 may be provided. For example, one separator 130 may be inserted between the first electrode 110 and the second electrode 120.

For example, one separator 130 may be provided. For example, separator 130 may include meandering portion 135. In the meandering portion 135, the separator 130 is folded into a meandering shape. The meandering shape may be expressed as, for example, a bellows shape, an accordion shape, or the like.

The meandering portion 135 includes a planar portion 131 and a folded portion 132. In the planar portion 131, the separator 130 extends in a planar shape. In the folded portion 132, the separator 130 is folded back. The folded portions 132 are disposed at both ends in the H direction. The separator 130 is folded so as to alternately sandwich the first electrode 110 or the second electrode 120. The planar portion 131 sandwiches the first electrode 110 or the second electrode 120. Separator 130 may further include, for example, an outer peripheral portion 136. The outer peripheral portion 136 may be wound so as to wrap around the meandering portion 135. The separator 130 may be folded back at both ends in the W direction to form a meandering portion.

The power storage cell 1 further includes an external terminal 300. The pair of external terminals 300 is fixed to the lid 220. The external terminal 300 is connected to the first electrode 110 or the second electrode 120. The external terminal 300 may be made of metal, for example. The external terminal may include Al, Cu, Ni, or the like. The external terminal 300 may have, for example, a rectangular parallelepiped outer shape. The external terminal 300 may be connected to a bus bar (not shown).

The pair of coupling members 400 connects the electrode tab and the external terminal 300. The electrode tab indicates the first electrode tab 116 or the second electrode tab 126. The two coupling members 400 may have substantially the same structure.

The coupling member 400 may include, for example, a current collecting tab 410, a sub-tab 420, and a coupling pin 430. The current collecting tab 410 includes a side portion 412 and an upper portion 414. The side portion 412 is located on the side of the electrode assembly 100 in the W direction. The upper portion 414 is located above the electrode assembly 100. The upper portion 414 extends inward in the W direction from the upper end of the side portion 412.

Sub-tab 420 connects the plurality of electrode tabs to current collecting tab 410. The sub-tab 420 may include a first end portion 422 and a second end portion 424. The first end portion 422 is connected to the plurality of electrode tabs. The second end portion 424 is connected to the side portion 412.

The coupling pin 430 connects the current collecting tab 410 to the external terminal 300. The coupling pin 430 couples the upper portion 414 and the external terminal 300. For example, the lower end portion of the coupling pin 430 may be inserted into a through hole provided in the upper portion 414.

The insulating member 500 insulates the case 200 from the coupling member 400. The insulating member 500 may include, for example, a first portion 510, a second portion 520, a third portion 530, and a fourth portion 540.

The first portion 510 is fixed to the upper surface of the lid 220. The first portion 510 is disposed between the lid 220 and the external terminal 300. The second portion 520 is fixed to the lower surface of the lid 220. The second portion 520 is disposed between the lid 220 and the upper portion 414. The second portion 520 is disposed between the lid 220 and the lower portion of the coupling pin 430. The third portion 530 is disposed between the coupling pin 430 and the lid 220. The third portion 530 has a cylindrical shape. The third portion 530 surrounds the coupling pin 430. The first portion 510, the second portion 520, and the third portion 530 are provided with through holes. The coupling pin 430 is inserted through the through hole.

The fourth portion 540 has a plate shape. It is fixed to the lower surface of the upper portion 414. The fourth portion 540 is disposed above the electrode assembly 100. In the fourth portion 540, a through hole is provided below the pressure-release valve 222. In the fourth portion 540, a through hole is also provided below the injection port 221.

What is claimed is:

1. A temporary sealing plug for temporarily closing an injection port of a power storage cell after injection, the temporary sealing plug comprising:
a central portion; and
a peripheral edge portion, wherein
when viewed in a plan view, the peripheral edge portion surrounds the central portion, and
a cut extending radially from the central portion toward the peripheral edge portion is formed.

2. The temporary sealing plug according to claim 1, comprising at least one selected from a group consisting of ethylene-propylene-diene rubber, perfluoroalkoxy fluororesin, and polytetrafluoroethylene.

3. The temporary sealing plug according to claim 1, wherein the central portion is raised.

4. A power storage cell comprising:
the temporary sealing plug according to claim 1;
a sealing plug;
a case;
an electrode assembly; and
an electrolyte solution, wherein
the case accommodates the electrode assembly and the electrolyte solution,
the case is provided with the injection port,
the sealing plug closes the injection port, and
the temporary sealing plug is disposed between the injection port and the sealing plug.

5. A method of manufacturing a power storage cell, the method comprising:
(a) preparing a case provided with an injection port;
(b) accommodating an electrode assembly in the case; and
(c) injecting an electrolyte solution into the case, wherein
the (c) includes the following (c1) to (c4) in this order:
(c1) attaching the temporary sealing plug according to claim 1 to the injection port;
(c2) inserting a nozzle into the cut of the temporary sealing plug;
(c3) injecting the electrolyte solution from the nozzle; and
(c4) pulling out the nozzle from the temporary sealing plug.
